(19) United States
(12) Patent Application Publication
(10) Pub. No.: US 2006/0201001 A1
(43) Pub. Date: Sep. 14, 2006

(54) Coated cutting member having a nitride hardened substrate

(75) Inventors: Dirk Herbert Johan Teeuw, Drachten (NL); Ype Bernardus Brada, Drachten (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/564,389

(22) PCT Filed: Jul. 8, 2004
(86) PCT No.: PCT/IB04/51161

§ 371 Date: Jan. 12, 2006

(30) Foreign Application Priority Data
Jul. 15, 2003 (EP) 03102161.1

(51) Int. Cl. B26B 21/60

(52) U.S. Cl. 30/346.54

(57) ABSTRACT

The invention relates to a cutting member (7) for use in a device for shaving hair. The cutting member comprises a steel substrate (15) which is provided with a cutting edge (9). At least a portion of a surface (27) of the substrate including the cutting edge is provided with a protective coating (19) having a hardness which is higher than a˜hardness of the steel substrate. According to the invention, the portion of the surface (27) of the substrate (15) provided with the coating (19) is nitride hardened. As a result, the substrate provides an improved mechanical supporting function for the coating. In this manner, the risk that the coating will break as a result of deformations of the substrate, which occur under', the influence of high mechanical loads on the coating and on the cutting edge (9), is considerably limited. Examples of suitable coatings (19) in combination with the nitride (hardened steel substrate (15) are diamond-Like carbon and coatings having a superlattice structure comprising carbon and a metal, e.g. Cr.

The invention relates to a cutting member for use in a device for shaving hair, said cutting member having a steel substrate which is provided with a cutting edge, at least a portion of a surface of the substrate including the cutting edge being provided with a coating having a hardness which is higher than a hardness of the steel substrate.

The invention further relates to a device for shaving hair, comprising a cutting member having a steel substrate which is provided with a cutting edge, at least a portion of a surface of the substrate including the cutting edge being provided with a coating having a hardness which is higher than a hardness of the steel substrate.

A cutting member and a device for shaving hair of the kinds mentioned in the opening paragraphs are known from EP-B-0 591 339. The known cutting member is a razor blade comprising a blade-shaped substrate made of stainless steel and provided with a straight wedge-shaped cutting edge. The known device for shaving hair is a safety razor comprising two such known razor blades which are arranged in a disposable shaving head. A portion of the surface of the substrate, which includes the cutting edge, is provided with a coating of diamond-like carbon (DLC), and an intermediate layer of molybdenum is provided between the substrate and the DLC coating to improve the adhesion of the coating to the substrate. The DLC coating has a relatively high hardness and resistance to wear, so that the resistance to wear of the cutting member and particularly of the wedge-shaped cutting edge is considerably improved, and the term of life of the cutting member is considerably prolonged. In addition, the DLC coating provides a relatively low coefficient of friction between the cutting member and the hair to be shaved, as a result of which the shaving comfort of the cutting member is considerably improved.

A disadvantage of the known cutting member and of the known device for shaving hair is that the steel substrate provides insufficient mechanical support for the coating. When relatively high mechanical loads are exerted on the cutting edge, the steel substrate will deform as a result of its relatively low hardness and stiffness. As a result, the coating may break because of its relatively high hardness. Said insufficient mechanical support is particularly present close to the cutting edge, because at this location the steel substrate is relatively thin.

It is an object of the invention to provide a cutting member and a device for shaving hair of the kinds mentioned in the opening paragraphs, wherein the mechanical supporting function of the steel substrate for the coating is improved, so that the risk that the coating will break under the influence of high mechanical loads is reduced.

In order to achieve this object, a cutting member in accordance with the invention is characterized in that at least the portion of the surface of the substrate provided with the coating is nitride hardened.

In order to achieve this object, a device for shaving hair in accordance with the invention is characterized in that the cutting member used therein is a cutting member in accordance with the invention.

During the manufacturing process of the cutting member in accordance with the invention, the portion of the surface of the steel substrate, on which the coating will be provided in a subsequent step of the manufacturing process, is nitride hardened by introducing nitrogen atoms or ions in said portion of the surface. As a result of the nitride hardening process, which is also called the nitriding process, a top layer comprising an iron nitride is formed immediately below said portion of the surface of the substrate, and a diffusion layer is formed below said top layer. Said top layer has a hardness and stiffness which are higher than the hardness and the stiffness of the steel substrate and which are closer to the hardness and the stiffness of the coating than the hardness and the stiffness of the steel substrate. Said diffusion layer has a hardness and a stiffness which gradually decrease when seen in a direction from the top layer towards the heart of the substrate. As a result, in a region immediately below the coating, the hardness and the stiffness of the steel substrate gradually decrease from a hardness and a stiffness, which are relatively close to the hardness and the stiffness of the coating, to the relatively low hardness and stiffness of the untreated base material of the steel substrate which is present in the heart of the substrate. Said gradual decrease of the hardness and the stiffness of the steel substrate leads to a considerably reduced amount of deformation of the steel substrate in said region immediately below the coating in case of high mechanical loads on the coating, so that the mechanical supporting function of the steel substrate for the coating is considerably improved and the risk that the coating will break under the influence of high mechanical loads is considerably reduced. An additional advantage of the nitride hardened substrate is that the substrate has an improved resistance against corrosion.

A particular embodiment of a cutting member in accordance with the invention is characterized in that the portion of the surface of the substrate provided with the coating is plasma nitrided. The plasma nitriding process provides the surface of the substrate with a top layer, comprising an iron nitride, and with a diffusion layer below said top layer which both have a thickness providing the steel substrate with a sufficient mechanical supporting function for most coatings having a hardness which is higher than the hardness of the steel substrate.

A particular embodiment of a cutting member in accordance with the invention is characterized in that the substrate is made from stainless steel. The nitride hardened stainless steel substrate provides a sufficient mechanical supporting function for most coatings having a hardness which is higher than the hardness of stainless steel.

A particular embodiment of a cutting member in accordance with the invention is characterized in that the coating comprises a plurality of stacked pairs of layers, wherein each pair comprises a first layer mainly comprising carbon and a second layer mainly comprising a metal, and each pair has a thickness between 1 and 10 nm. Said coating is called a superlattice coating and results both in a considerably improved resistance to wear of the cutting member, i.e. a considerably prolonged life time of the cutting member, and in a considerably improved shaving comfort of the cutting member, i.e. a considerably reduced coefficient of friction between the cutting member and the hair and considerably reduced cutting forces. It appeared that, in particular for this coating, the nitride hardened steel substrate provides an excellent mechanical supporting function.

A further embodiment of a cutting member in accordance with the invention is characterized in that the second layer comprises Cr, Nb, Mo, Ti, V, or W. Said metals provide the coating with a hardness which is superior to the average hardness of other known coatings. As a result, in this embodiment the mechanical supporting function of the nitride hardened substrate will provide the coating with a strongly improved durability under circumstances of high mechanical loads.

A further embodiment of a cutting member in accordance with the invention is characterized in that the coating has a thickness between 50 and 200 nm. It was found that, if the coating has an overall thickness between 50 and 200 nm, on the one hand the coating has a sufficient number of pairs of layers to achieve the properties of a superlattice coating, while on the other hand the thickness of the coating is sufficiently small to achieve a sufficient sharpness of the coated cutting edge and hence sufficiently low cutting forces.

A particular embodiment of a cutting member in accordance with the invention is characterized in that the coating comprises diamond-like carbon (DLC). Said coating results both in an improved resistance to wear of the cutting member, i.e. a prolonged life time of the cutting member, and in an improved shaving comfort of the cutting member, i.e. a reduced coefficient of friction between the cutting member and the hair and reduced cutting forces. It appeared that, in particular for this coating, the nitride hardened steel substrate provides an improved mechanical supporting function. An additional advantage is that the nitride hardening process improves the resistance of the steel substrate against deterioration of its mechanical and other properties, which occurs under the influence of high temperatures occurring during the deposition of the DLC coating in the manufacturing process of the cutting member.

Embodiments of a cutting member and a device for shaving hair in accordance with the invention are described in the following with reference to the drawings, in which

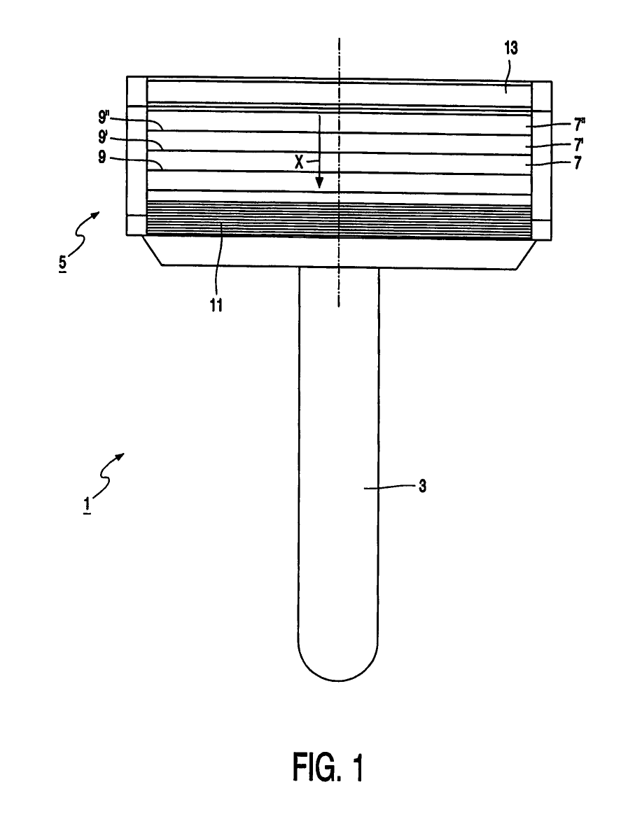

FIG. 1 shows a device for shaving hair in accordance with the invention,

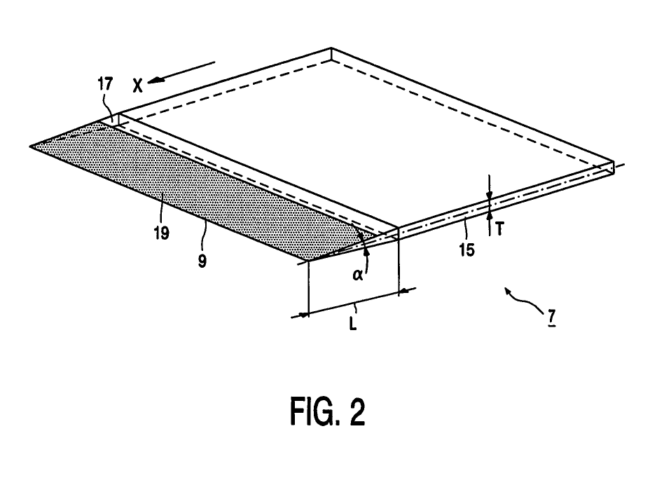

FIG. 2 shows a first embodiment of a cutting member according to the invention used in the device of FIG. 1,

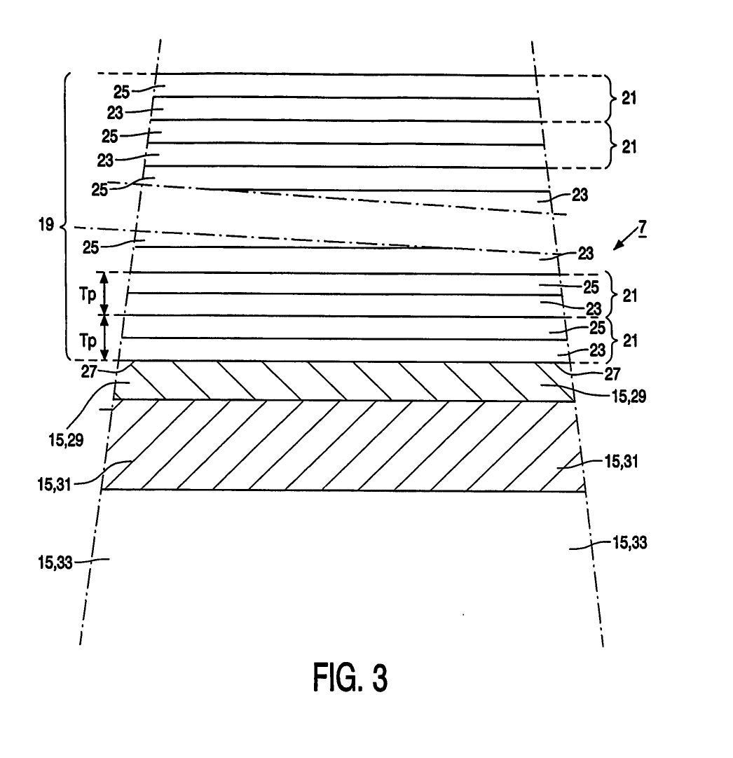

FIG. 3 schematically shows a cross-section of a protective coating of the cutting member of FIG. 2, and

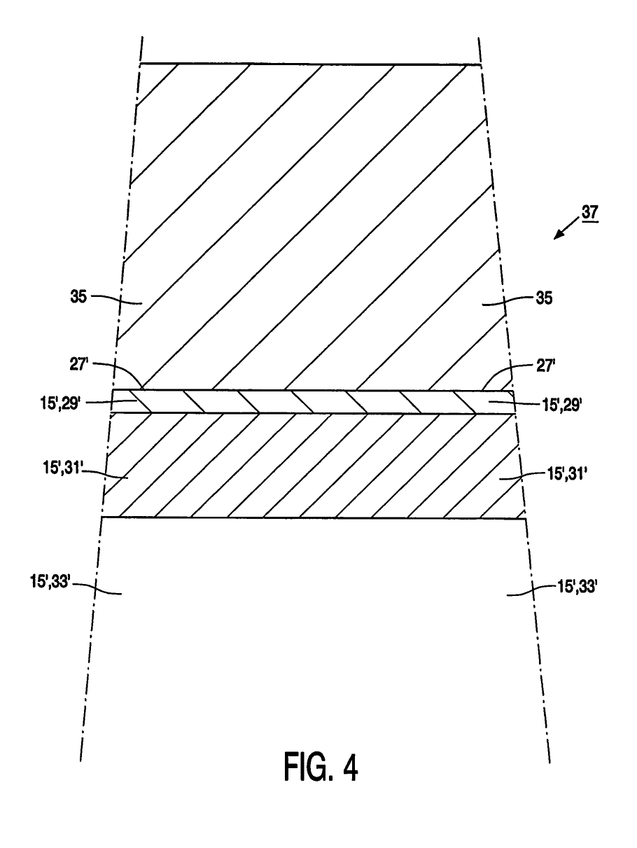

FIG. 4 schematically shows a cross-section of a protective coating of a second embodiment of a cutting member according to the invention.

The device for shaving hair in accordance with the invention shown in FIG. 1 is a so-called safety razor and comprises a base portion 1 having a grip 3. The device further comprises a disposable shaving head 5 which is releasibly mounted to the base portion 1. The shaving head 5 comprises three stainless steel cutting members 7, 7′, 7″ according to the invention which are each provided with a straight cutting edge 9, 9′, 9″. The cutting edges 9, 9′, 9″ are oriented parallel with respect to each other and define a cutting direction X in which the shaving head 5 is to be moved over a skin with hairs to be shaved, said cutting direction X extending perpendicular to the cutting edges 9, 9′, 9″. The shaving head 5 further comprises a first skin supporting member 11, which is profiled and which goes in front of the cutting members 7, 7′, 7″ when the shaving head 5 is moved in the cutting direction X so as to have a skin stretching effect. A second skin supporting member 13 is arranged in the shaving head 5 behind the cutting members 7, 7′, 7″.

FIG. 2 shows the cutting member 7 in detail. The cutting members 7′ and 7″ are identical to the cutting member 7. The cutting member 7 comprises a blade-shaped substrate 15 made of stainless steel. The cutting edge 9 constitutes the tip of a wedge-shaped portion 17 of the substrate 15. In the embodiment shown the substrate has a maximal thickness T of approximately 0.1 mm, and the wedge-shaped portion 17 has a main tip angle α of approximately 12°, so that a length L of the wedge-shaped portion 17 is approximately 0.5 mm. The tip of the wedge-shaped portion 17, which is not visible in detail in FIG. 2, is rounded and has an end radius which is smaller than approximately 100 nm so as to provide the cutting edge 9 with a sufficient sharpness. A preferred value of said end radius is approximately 40 nm.

As shown in FIG. 2, a major portion of the surface of the wedge-shaped portion 17 is provided with a protective coating 19, said portion including the cutting edge 9. As shown in FIG. 3, the coating 19 comprises a plurality of stacked pairs 21 of layers. Each pair 21 of layers comprises a first layer 23 mainly comprising carbon (C) and a second layer 25 mainly comprising chromium (Cr). In the embodiment shown in FIG. 3, each pair 21 of layers has a thickness Tₚ of approximately 1.8 nm, the first layers 23 and the second layers 25 having approximately equal thicknesses, and the coating 19 has an overall thickness of approximately 100 nm. Thus the coating 19 has a nano-scale multi-layered structure, wherein each layer 23, 25 has a thickness of only a small number of times the diameter of a single atom. Within such a structure, the atoms present in the adjacent layers 23, 25 of the coating 19 will be arranged in a so-called superlattice. A number of physical properties of such a superlattice are superior to the physical properties, which the materials of the layers 23, 25 have individually and which the coating 19 would have if the thickness of the individual layers 23, 25 would be much larger. Since in the embodiment shown in FIG. 3 the first layer 23 of each pair 21 of layers mainly comprises carbon, the coating 19 provides a coefficient of friction between the cutting member 7 and the hair to be shaved which is considerably lower than the coefficient of friction which would be present without the coating 19. Since in the embodiment shown in FIG. 3 the second layer 25 of each pair 21 of layers mainly comprises Cr, the coating 19 has a hardness which equals approximately four times the hardness of Cr and which, as a result, is superior to the hardness of the stainless steel substrate 15. As a result, the coating 19 provides the cutting member 7 with a considerably prolonged life time and with a considerably improved shaving comfort.

The stainless steel substrate 15 mechanically supports the coating 19. Since the hardness and stiffness of the stainless steel substrate 15 are inferior to the hardness and stiffness of the coating 19, the deformation of the substrate 15 under the influence of mechanical loads exerted on the cutting member 7 would be considerably larger than the deformation of the coating 19 if no further measures were taken. Because of the relatively large deformation of the substrate 15, said mechanical support function of the substrate 15 would deteriorate, and as a result their would be a considerable risk that the coating 19 would break under the influence of relatively high mechanical loads. This risk would be particularly present in the region near the cutting edge 9, where the substrate 15 is relatively thin.

In order to improve the mechanical supporting function of the substrate 15 for the coating 19 and to reduce the risk that the coating 19 will break under the influence of high mechanical loads exerted on the cutting edge 9, the portion of the surface of the substrate 15, on which the coating 19 is provided, is nitride hardened. For this purpose, during the manufacturing process of the cutting member 7, said portion of the surface of the substrate 15 is subject to a plasma nitride hardening process before the coating 19 is provided thereon in a next manufacturing step. The plasma nitride hardening process, which is also called the plasma nitriding process, is an advanced surface hardening process by means of which nitrogen ions are introduced in said portion of the surface of the substrate 15. According to said process, a strong electrostatic field is established between said portion of the surface of the substrate 15 and an electrode, which are present in a process chamber containing nitrogen gas. As a result of the electrostatic field, the nitrogen gas is ionized, the nitrogen ions are accelerated towards the substrate 15 and diffuse into said portion of the surface of the substrate 15. As a result, as shown in FIG. 3, a top layer 29 comprising an iron nitride is formed immediately below said portion of the surface 27 of the substrate 15, and a diffusion layer 31 is formed below said top layer 29. Typical values of the thickness of the top layer 29 are within the range from a few tens of nanometers to 5 micrometers, typical values for the thickness of the diffusion layer 31 are within the range from a few micrometers to 200 micrometers. In the embodiment shown in FIG. 3, the thicknesses of the top layer 29 and the diffusion layer 31 are close to the lower limits of said ranges. It is noted that in FIG. 3 the thicknesses of the pairs 21 of layers of the coating 19 and of the top layer 29 and the diffusion layer 31 are not shown in the correct proportions. The top layer 29 has a hardness and stiffness which are considerably higher than the hardness and the stiffness of the untreated base material 33 of the stainless steel substrate 15 and which are closer to the hardness and the stiffness of the coating 19 than the hardness and the stiffness of said untreated base material 33. The diffusion layer 31 has a hardness and a stiffness which, seen in a direction from the coating 19 towards the untreated base material 33, gradually decrease from the hardness and stiffness of the top layer 29 to the hardness and stiffness of the untreated base material 33. As a result, in a region immediately below the coating 19, the values of the hardness and the stiffness do not decrease stepwise, as would be the case when the surface 27 of the substrate 15 would not be nitride hardened, but decrease gradually. As a result, the amount of deformation of the stainless steel substrate 15 in said region immediately below the coating 19 under the influence of mechanical loads on the coating 19 is considerably reduced, so that the mechanical supporting function of the substrate 15 for the coating 19 is considerably improved.

The plasma nitriding process is an advanced surface hardening process, and by means of said process values of the thicknesses of the top layer 29 and the diffusion layer 31 can be achieved which are sufficient to provide a sufficient mechanical supporting function of the substrate 15 for the coating 19. However, other kinds of nitriding processes can also be used in the manufacturing process of a cutting member in accordance with the invention, such as a liquid nitriding process. It is further noted that the invention is limited to substrates made from steel, but that the substrate may also be made from a different kind of steel than stainless steel, such as carbon steel.

It is further noted that the pairs 21 of layers of the coating 19 may have a thickness Tₚ different from 1.8 nm as in the embodiment of FIG. 3. It was found that the hardness of the coating 19 is dependent on the thickness Tₚ of the pairs 21 of layers and that the hardness has a maximal value of approximately four times the hardness of Cr if the thickness Tₚ is between 1.6 and 2.0 nm. If the thickness Tₚ is outside this range, however, the coating 19 may still have a hardness which is superior to the hardness of Cr. Such a superior hardness is particularly achieved when the thickness Tₚ is such that the coating 19 has a superlattice structure. It was found that a superlattice coating of carbon and chromium layers is obtained if the thickness Tₚ is between 1 and 10 nm. It is further noted that the coating 19 may have an overall thickness different from 100 nm as in the embodiment of FIG. 3. On the one hand, the overall thickness of the coating 19 must be such that the coating 19 has a sufficient number of pairs 21 of layers to obtain the properties of a superlattice coating. It was found that a minimal overall thickness of 50 nm is necessary to provide a sufficient number of pairs 21 of layers. On the other hand, the overall thickness of the coating 19 must be sufficiently small to obtain a sufficient sharpness of the coated cutting edge 9 and hence to achieve sufficiently low cutting forces of the cutting member 7. It was found that acceptable values of the cutting force are obtained if the overall thickness of the coating 19 is below 200 nm. It appeared that, in particular for a coating with a superlattice structure such as the coating 19, the nitride hardened stainless steel substrate 15 provides an excellent mechanical supporting function. It was in particular found that the nitride hardened stainless steel substrate 15 also provides an excellent mechanical supporting function for coatings having a superlattice structure with carbon and with another metal than Cr, in particular with niobium (Nb), molybdenum (Mo), titanium (Ti), vanadium (V), or tungsten (W), that will also provide a superior hardness of the superlattice coating. However, a skilled person will be able to find also other suitable metals which will provide a superior hardness in combination with carbon.

FIG. 4 schematically shows a cross-section of a protective coating 35 of a second embodiment of a cutting member 37 according to the invention, which can be used in a device for shaving hair according to the invention instead of the cutting member 7 described herebefore. In FIG. 4 parts of the cutting member 37, which correspond with parts of the cutting member 7, are indicated with corresponding reference numbers. In the following, only the main differences between the cutting member 37 and the cutting member 7 will be briefly discussed.

The cutting member 37 mainly differs from the cutting member 7 in that the protective coating 35 comprises a uniform layer of diamond-like carbon (DLC). In the embodiment shown, the coating 35 of DLC has a thickness of approximately 100 nm. The coating 35 results both in an improved resistance to wear of the cutting member 37, i.e. a prolonged life time of the cutting member 37, and in an improved shaving comfort of the cutting member 37, i.e. a reduced coefficient of friction between the cutting member 37 and a hair to be shaved and reduced cutting forces. Also in this embodiment, the nitride hardened stainless steel substrate 15′ provides an improved mechanical supporting function. An additional advantage is that, as a result of the nitride hardening process, the resistance of the stainless steel substrate 15′ against deterioration of its mechanical and other properties, which occurs under the influence of the high temperatures occurring during the deposition of the DLC coating 35 in the manufacturing process of the cutting member 37, is considerably improved.

It is noted that the invention also covers cutting members which are provided with a coating of a material other than the material of the coatings 19 and 35 of the cutting members 7 and 37 described herebefore. In general such a coating should have a hardness which is considerably higher than the hardness of the steel substrate, so that the coating provides at least an increased durability of the cutting member. Examples of such alternative coatings are tungsten carbide, titanium nitride, and boron nitride, and the skilled person will be able to find numerous other examples of such coatings comprising metals, metal oxides, metal nitrides, metal carbides, or metal borides or mixtures thereof. In general, the nitride hardened steel substrate of a cutting member in accordance with the invention will provide an improved mechanical supporting function for all these kinds of coatings in view of the gradient of the hardness and of the stiffness which is present in the region immediately below the surface of the substrate.

In the embodiment of FIG. 1, the device for shaving hair in accordance with the invention comprises a disposable shaving head 5 in which three cutting members 7, 7′, 7″ according to the invention are arranged, said shaving head 5 being releasibly mounted to the base portion 1. It is noted that the invention also covers embodiments in which one or more cutting members are arranged in a shaving head which is not releasable from the base portion. The invention further covers embodiments in which the device for shaving hair comprises a number of cutting members in accordance with the invention different from three, for example one, two, or four cutting members. It is further noted that the expression “device for shaving hair” in the claims does not only cover a device of the kind shown in FIG. 1 comprising a base portion with a shaving head comprising cutting members mounted thereto, but also covers disposable or non-disposable shaving heads of a kind like the shaving head 5 in FIG. 1, which comprise at least one cutting member according to the invention and are suitable for being mounted to a base portion of a shaver or razor.

In the embodiment of FIG. 1, the cutting members 7, 7′, 7″ are mounted in a fixed or in a substantially fixed position in the shaving head 5. It is finally noted that the invention also covers embodiments of a device for shaving hair in which one or more than one cutting member in accordance with the invention can be driven with respect to a base portion of the device by means of a suitable driving mechanism provided in said device. The cutting member may, for example, make a reciprocating or vibrating motion with respect to the base portion during operation so as to provide, for example, a reduction of the cutting forces.

1. A cutting member for use in a device for shaving hair, said cutting member having a steel substrate which is provided with a cutting edge, at least a portion of a surface of the substrate including the cutting edge being provided with a coating having a hardness which is higher than a hardness of the steel substrate, characterized in that at least the portion of the surface of the substrate provided with the coating is nitride hardened.

2. A cutting member as claimed in claim 1, characterized in that the portion of the surface of the substrate provided with the coating is plasma nitrided.

3. A cutting member as claimed in claim 1, characterized in that the substrate is made from stainless steel.

4. A cutting member as claimed in claim 1, characterized in that the coating comprises a plurality of stacked pairs of layers, wherein each pair comprises a first layer mainly comprising carbon and a second layer mainly comprising a metal, and each pair has a thickness between 1 and 10 nm.

5. A cutting member as claimed in claim 4, characterized in that the second layer comprises Cr, Nb, Mo, Ti, V, or W.

6. A cutting member as claimed in claim 4, characterized in that the coating has a thickness between 50 and 200 nm.

7. A cutting member as claimed in claim 1, characterized in that the coating comprises diamond-like carbon (DLC).

8. A device for shaving hair, comprising a cutting member having a steel substrate which is provided with a cutting edge, at least a portion of a surface of the substrate including the cutting edge being provided with a coating having a hardness which is higher than a hardness of the steel substrate, characterized in that the cutting member is a cutting member as claimed in claim 1.
